(19) United States
(12) Patent Application Publication
(10) Pub. No.: US 2016/0065600 A1
(43) Pub. Date: Mar. 3, 2016

(54) APPARATUS AND METHOD FOR AUTOMATICALLY DETECTING MALICIOUS LINK

(71) Applicant: ELECTRONICS AND TELECOMMUNICATIONS RESEARCH INSTITUTE, Daejeon (KR)

(72) Inventors: Suk won LEE, Daejeon (KR); Geun Yong KIM, Daejeon (KR); Taek kyu LEE, Daejeon (KR); Myeong Ryeol CHOI, Daejeon (KR); Soonjwa HONG, Daejeon (KR); Seongtaek CHEE, Daejeon (KR)

(21) Appl. No.: 14/748,396

(22) Filed: Jun. 24, 2015

(30) Foreign Application Priority Data
Sep. 2, 2014 (KR) 10-2014-0116005

(51) Int. Cl. H04L 29/06; G06F 17/30

(52) U.S. Cl. CPC H04L 63/1416; H04L 63/0236; G06F 17/30106; G06F 17/30887

(57) ABSTRACT

An apparatus and method for automatically detecting a malicious link. The apparatus includes a threat information collection unit, a priority management unit, a malicious link collection unit, a malicious link analysis unit, and a malicious link tracking unit. The threat information collection unit collects threat information, and identifies whether a malicious link is present in each target site. The priority management unit determines the priorities of the target sites, and performs the assignment and management of the target sites in order to collect and analyze a malicious link. The malicious link collection unit collects the uniform resource locator (URL) of the malicious link from the target sites. The malicious link analysis unit analyzes a call correlation based on the collected URL, and analyzes the malicious link through pattern matching. The malicious link tracking unit tracks the real-time changing state of the malicious link.

### CROSS-REFERENCE TO RELATED APPLICATION

This application claims the benefit of Korean Patent Application No. 10-2014-0116005, filed Sep. 2, 2014, which is hereby incorporated by reference herein in its entirety.

### BACKGROUND

1. Technical Field

Embodiments of the present invention relate generally to an apparatus and method for automatically detecting a malicious link and, more particularly, to an apparatus and method for tracking the changing state of a malicious link in real time by automatically collecting and analyzing the malicious link used to distribute malware.

2. Description of the Related Art

A crawling technique, is used to collect malicious links present in home pages. If the crawling technique is used, in-depth collection can be performed on a home page when a pattern suspected to be a malicious link is present in the content of the main page of the home page.

However, if a hacker configures a link several times in a complicated manner without using a simple link structure and then distributes malware, the malicious link collection technique cannot collect a malicious link because a pattern suspected to be a malicious link is not present in a main page. Furthermore, a problem arises in that a malicious link cannot be collected if the content of a web page has been obfuscated or cannot be parsed.

In order to overcome the above problems, there is a technology for collecting a malicious link using a dynamic behavior simulation method. A malicious link collection technology using such a dynamic behavior simulation method can collect a malicious link regardless of whether or not a web page has been obfuscated or can be parsed. However, an existing malicious link collection technology using the dynamic behavior simulation method is unable to rapidly collect malicious links. Furthermore, it is difficult for an information specialist or security control person to use the existing malicious link collection technology as a technology for rapid countermeasures because the existing malicious link collection technology does not track the real-time changing state of a malicious link that distributes malware within a short period of time and then disappears.

As a related technology, Korean Patent No. 10-1400680 discloses a technology for automatically detecting and collecting the behavior of distributing malware in a web site.

In Korean Patent No. 10-1400680, malware is determined to be distributed only if an abnormal event occurs when a web site is visited. Accordingly, if a malicious script is present in a web site but malware is not executed because exploitation does not occur, malware is determined not to be detected. As a result, the evidence of the distribution of malware cannot be acquired.

### SUMMARY

At least one embodiment of the present invention is directed to the provision of an apparatus and method for tracking the real-time changing state of a malicious link in real time by automatically collecting malicious links used to distribute malware from a home page and analyzing the collected malicious links.

In accordance with an aspect of the present invention, there is provided an apparatus for automatically detecting a malicious link, including: a threat information collection unit configured to collect open threat information related to target sites and to identify whether a malicious link is present in each of the target sites; a priority management unit configured to determine the priorities of the target sites and to perform assignment and management of the target sites in order to collect and analyze a malicious link; a malicious link collection unit configured to collect the uniform resource locator (URL) of the malicious link from the target sites; a malicious link analysis unit configured to analyze a call correlation based on the collected URL of the malicious link and to analyze the malicious link through pattern matching; and a malicious link tracking unit configured to track the real-time changing state of the analyzed malicious link.

The threat information collection unit may include one or more threat information collection modules; and the threat information collection module may access a specific web site that discloses information about the malicious link based on a list of previously stored target sites, may collect information about a history of the distribution of the malicious link related to the specific web site, and may identify whether a malicious link is present in each of the target sites.

The priority management unit may include: a checking priority determination module configured to check a checking priority object based on a list of previously stored target sites and to determine the priority of each of the target sites based on previously stored threat information and detection information; and a target site assignment module configured to assign priorities to the respective target sites based on the results of the determination of the priorities of the respective target sites.

The malicious link collection unit may include one or more malicious link collection modules; and the malicious link collection module may collect the URL of the malicious link from the target sites using a dynamic behavior simulation method.

The malicious link collection module may include: a target site access module configured to change an Internet Protocol (IP) address prior to accessing the target sites and to access the target sites; a URL address collection module configured to collect the addresses of the URLs of the accessed target sites; and a URL address storage module configured to store the collected addresses of the URLs.

The URL address collection module may collect the addresses of the URLs based on network snipping if the target sites are important sites.

The URL address collection module may collect the addresses of the URLs based on web browser hooking if the target sites are not important sites.

The malicious link collection module may further include a virtual machine infection checking module configured to check whether a virtual machine has been infected with malware.

The malicious link analysis unit may include one or more malicious link analysis modules; and the malicious link analysis module may include: a URL call correlation generation module configured to generate a URL call correlation based on referer information included in the configuration information of the URLs of the target sites; a URL access module configured to change an IP address prior to accessing a URL, to access the URL, and to store the accessed URL as a source file; a URL verification module configured to determine the type of malicious link with respect to an address of the URL and the content of the source file through pattern matching and the URL call correlation; a real-time notification module configured to provide notification of a URL, determined to be a malicious link, in real time; and a detection result storage module configured to store the result of the determination of the URL verification module.

The malicious link tracking unit may include one or more malicious link tracking modules; and the malicious link tracking module may include: a URL access module configured to change an IP address prior to accessing a URL, to access the URL, and to store the accessed URL as a source file; a URL comparison module configured to compare the source file of the URL access module with the source file of the same URL that has been previously tracked based on previously stored tracking information; a URL verification module configured to verify the changing state of a malicious link in real time by performing pattern matching on the address of the URL and the content of the source file based on previously stored suspicious patterns and malicious patterns; a detection result storage module configured to store the result of the real-time changing state of the malicious link; and a real-time notification module configured to provide notification of a changed URL in real time as the state of the URL verified via the URL verification module is changed.

In accordance with an aspect of the present invention, there is provided a method of automatically detecting a malicious link, including: determining, by a priority management unit, checking the priorities of target sites based on open threat information and detection information related to the target sites; collecting, by a malicious link collection unit, the URL of a malicious link from the target sites; analyzing, by a malicious link analysis unit, a call correlation based on the collected URL of the malicious link and analyzing the malicious link through pattern matching; and tracking, by a malicious link tracking unit, a real-time changing state of the analyzed malicious links.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of an apparatus for automatically detecting a malicious link according to an embodiment of the present invention;

FIG. 2 is a diagram illustrating the internal components of the apparatus for automatically detecting a malicious link illustrated in FIG. 1;

FIG. 3 is a flowchart illustrating a procedure for determining the checking priorities of target sites in a method of automatically detecting a malicious link according to an embodiment of the present invention;

FIG. 4 is a flowchart illustrating a procedure for assigning target sites to a queue repository and managing the target sites in order to process the collection and analysis of malicious links in parallel in the method of automatically detecting a malicious link according to an embodiment of the present invention;

FIG. 5 is a diagram illustrating the internal components of a malicious link collection module of FIG. 2;

FIG. 6 is a flowchart illustrating the dynamic procedure of the malicious link collection module for collecting malicious links using a dynamic behavior simulation method in the method of automatically detecting a malicious link according to an embodiment of the present invention;

FIG. 7 is a diagram illustrating the internal components of a malicious link analysis module of FIG. 2;

FIG. 8 is a flowchart illustrating the dynamic procedure of the malicious link analysis module for detecting and analyzing a malicious link in the method of automatically detecting a malicious link according to an embodiment of the present invention;

FIG. 9 is a diagram illustrating the internal components of a malicious link tracking module of FIG. 2;

FIG. 10 is a flowchart illustrating the dynamic procedure of the malicious link tracking module for tracking the real-time changing state of a malicious link and providing notification of the malicious link in the method of automatically detecting a malicious link according to an embodiment of the present invention; and

FIG. 11 is a general flowchart illustrating the method of automatically detecting a malicious link according to an embodiment of the present invention.

### DETAILED DESCRIPTION

The present invention may be subjected to various modifications and have various embodiments. Specific embodiments are illustrated in the drawings and described in detail below.

However, it should be understood that the present invention is not intended to be limited to these specific embodiments but is intended to encompass all modifications, equivalents and substitutions that fall within the technical spirit and scope of the present invention.

The terms used herein are used merely to describe embodiments, and not to limit the inventive concept. A singular form may include a plural form, unless otherwise defined. The terms, including “comprise,” “includes,” “comprising,” “including” and their derivatives specify the presence of described shapes, numbers, steps, operations, elements, parts, and/or groups thereof, and do not exclude presence or addition of at least one other shapes, numbers, steps, operations, elements, parts, and/or groups thereof.

Unless otherwise defined herein, all terms including technical or scientific terms used herein have the same meanings as commonly understood by those skilled in the art to which the present invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Embodiments of the present invention are described in greater detail below with reference to the accompanying drawings. In order to facilitate the general understanding of the present invention, like reference numerals are assigned to like components throughout the drawings and redundant descriptions of the like components are omitted.

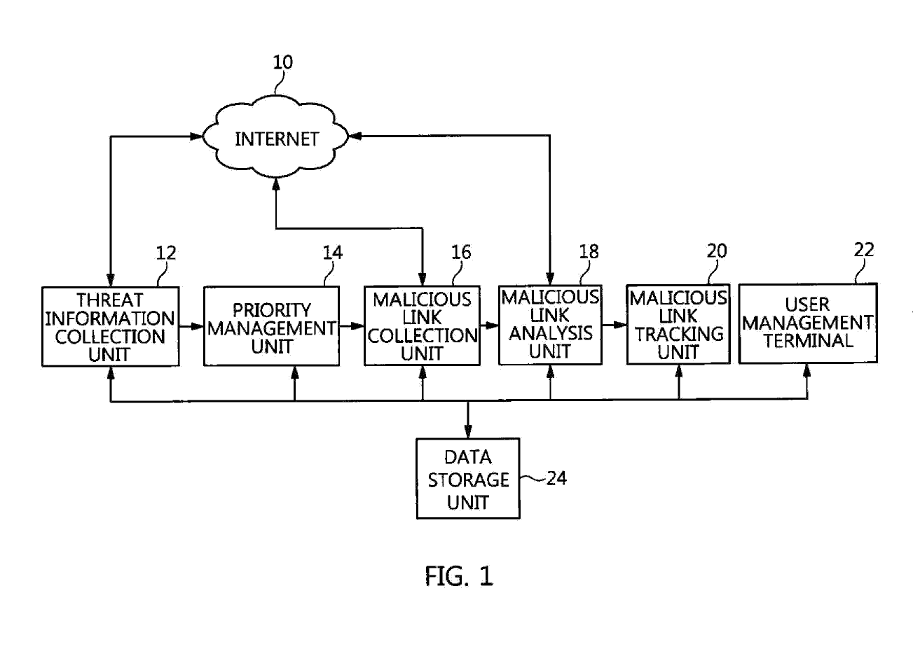

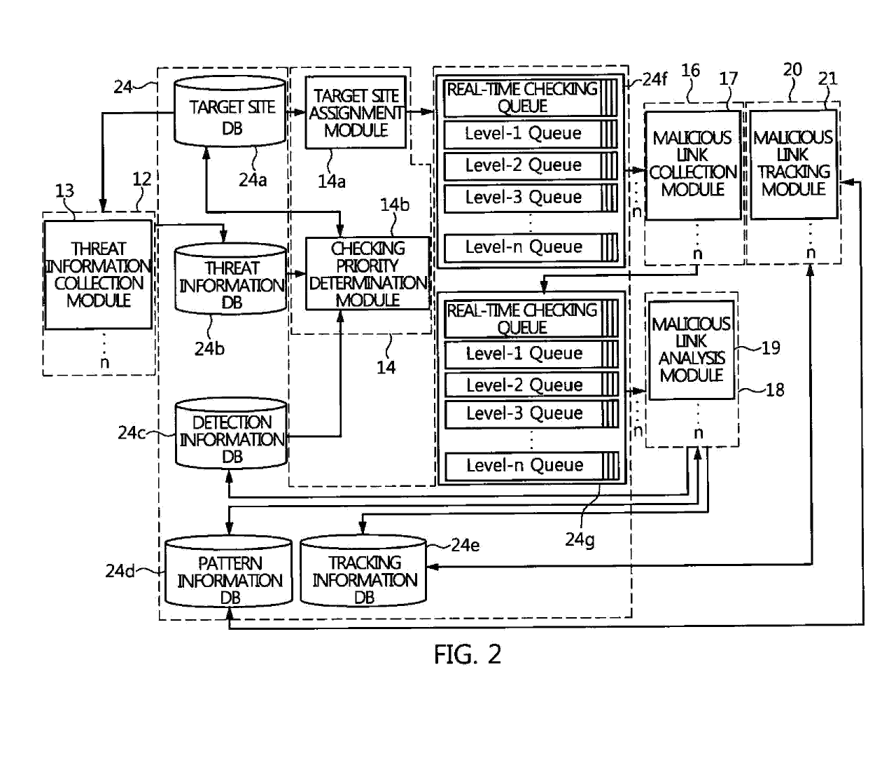

FIG. 1 is a diagram illustrating the configuration of an apparatus for automatically detecting a malicious link according to an embodiment of the present invention, and FIG. 2 is a diagram illustrating the internal components of the apparatus for automatically detecting a malicious link illustrated in FIG. 1.

The apparatus for automatically detecting a malicious link according to the present embodiment includes a threat information collection unit 12, a priority management unit 14, a malicious link collection unit 16, a malicious link analysis unit 18, a malicious link tracking unit 20, a user management terminal 22, and a data storage unit 24.

The threat information collection unit 12 collects threat information open in relation to target sites over the Internet 10, and identifies whether a malicious link is present or not with respect to each of the target sites. The threat information collection unit 12 may include one or more threat information collection modules 13. The threat information collection module 13 extracts a list of target sites from a target site DB 24a in which information about the uniform resource locators (URLs) and checking priority of the target sites have been stored. The threat information collection module 13 accesses a specific web site that discloses information about malicious links over the Internet 10 based on the list of target sites. Thereafter, each of the threat information collection modules 13 collects information about a history of the distribution of a malicious link related to a corresponding target site, identifies whether a malicious link is present with respect to each target site, and stores the result of the identification in a threat information DB 24b.

The priority management unit 14 determines the checking priorities of the target sites. The priority management unit 14 performs the assignment and management of the target sites so that the collection and analysis of malicious links can be processed in parallel. The priority management unit 14 includes a target site assignment module 14a, and a checking priority determination module 14b.

The target site assignment module 14a extracts results into which checking priorities have been incorporated from the target site DB 24a, and assigns the results to a collection object queue repository 24f according to priority.

The checking priority determination module 14b extracts a list of target sites from the target site DB 24a, checks a checking priority object, determines priorities corresponding to the respective target sites based on the information of the threat information DB 24b and the detection information DB 24c, and incorporates corresponding results into the target site DB 24a. In this case, the threat information DB 24b stores information about a history of the distribution of a malicious link related to each of the target sites and information about whether a malicious link is present in the target site. The detection information DB 24c stores the result of the malicious link detection of the target site for each date.

The malicious link collection unit 16 collects the malicious link URLs of the target sites over the Internet 10 using a dynamic behavior simulation method. The malicious link collection unit 16 may include one or more malicious link collection modules 17. Each of the malicious link collection modules 17 checks whether a target site is present in the collection object queue repository 24f, retrieves information about the target site if the target site is found to be present, and collects the malicious link uniform resource locator (URL) of the target site from the target site using a dynamic behavior simulation method. The malicious link collection module 17 stores the results of the collection in an analysis object queue repository 24g. Real-time checking queues as well as checking priority queues are also present in the collection object queue repository 24f and the analysis object queue repository 24g. The real-time checking queues are used to receive target sites that need to be checked in real time from the user management terminal 22 through a GUI and to collect and analyze the target sites.

The malicious link analysis unit 18 analyzes a call correlation based on a malicious link URL collected from the malicious link collection unit 16, and analyzes a malicious link by performing pattern matching. The malicious link analysis unit 18 may include one or more malicious link analysis modules 19. In other words, if the URL of a collected target site is present in the analysis object queue repository 24g, the malicious link analysis unit 18 retrieves the URL of the corresponding target site and analyzes the call correlation of a malicious link. Furthermore, the malicious link analysis unit 18 analyzes the malicious link (i.e., determines whether the type of malicious link is malicious, suspicious, or abnormal) through pattern matching using a suspicious pattern, present in a pattern information DB 24d, and pattern information, determined to be malicious, as sources. In this case, a detection time, target site URL, a malicious link URL, detected pattern information, MD5, and a URL source file related to a URL determined to be a malicious link are stored in the detection information DB 24c. Furthermore, in order to track a real-time changing state, the URL of the malicious link is stored in a tracking information DB 24e.

If the source file of a malicious link has a portable executable (PE) format or if a target site from which a malicious link has been detected is an important site set via the user management terminal 22, the malicious link analysis unit 18 notifies an information specialist or security control person of the source file or the target site in real time via e-mail or SMS.

The malicious link tracking unit 20 tracks the real-time changing state of a malicious link that is determined to be a malicious link by the malicious link analysis unit 18. The malicious link tracking unit 20 may include one or more malicious link tracking modules 21. In other words, the malicious link tracking unit 20 extracts a malicious link URL from the tracking information DB 24e, and accesses the malicious link. Furthermore, the malicious link tracking unit 20 tracks whether the corresponding malicious link has been activated or deactivated. Furthermore, the malicious link tracking unit 20 tracks the changing state of the malicious link through pattern matching using information about a suspicious pattern, which is present in the pattern information DB 24d and suspected to be malicious, but which may be used even in a normal link, and a malicious pattern, which has the characteristics of being used only in a malicious link, as sources. Accordingly, if the malicious link is changed from a deactivation state to an activation state or if a detected pattern is changed, the malicious link tracking unit 20 notifies an information specialist or security control person of the malicious link in real time via e-mail or SMS.

The user management terminal 22 manages target sites in order to collect malicious links, manages information about detected malicious links, and also manages the changing states of the malicious links through real-time tracking. Furthermore, the user management terminal 22 executes a command in order to detect a malicious link in a specific target site in real time.

The data storage unit 24 stores a variety of types of collected information and management information required for system management. The data storage unit 24 includes the target site DB 24a, the threat information DB 24b, the detection information DB 24c, the pattern information DB 24d, the tracking information DB 24e, the collection object queue repository 24f, and the analysis object queue repository 24g. In this case, the collection object queue repository 24f and the analysis object queue repository 24g are used for the collection and analysis of malicious links to be processed in parallel.

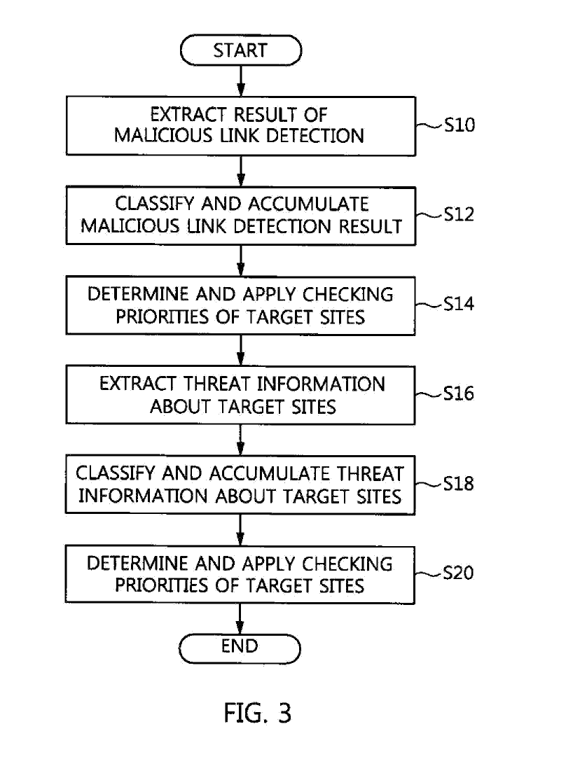

FIG. 3 is a flowchart illustrating a procedure for determining the checking priorities of target sites in a method of automatically detecting a malicious link according to an embodiment of the present invention.

The determination of the priorities of target sites is performed based on threat information and information about a malicious link that is autonomously detected. The determination of the priorities of target sites may be viewed as being performed by the priority management unit 14.

Primarily, the priority management unit 14 extracts the results of the malicious link detection of target sites stored in the detection information DB 24c at step S10. In this case, the priority management unit 14 may extract the results of the malicious link detection at a specific cycle, such as a predetermined time or date received via the user management terminal 22.

The priority management unit 14 classifies the type of corresponding malicious link as malicious, suspicious or abnormal based on the extracted results of the malicious link detection and accumulates the frequencies of detected target sites based on each classification result at step S12.

Thereafter, the priority management unit 14 arranges the cumulative result values in descending order, and determines the checking priorities of the target sites. For example, the priority management unit 14 determines the checking priority of a target site, classified as malicious, to correspond to a hacking site. The priority management unit 14 determines the checking priority of a target site, classified as suspicious, to correspond to a suspicious site. The priority management unit 14 determines the checking priority of a target site, classified as abnormal, to correspond to an abnormal site. Since a target site determined not to belong to any of the three types does not have a history of the detection of a malicious link, the priority management unit 14 determines the checking priority of the corresponding target site to correspond to a normal site. Thereafter, the priority management unit 14 applies information about the priority of the target site that has been determined as described above to the target site DB 24a at step S14.

Secondarily, the priority management unit 14 extracts threat information about the target sites stored in the threat information DB 24b at step S16. In this case, the priority management unit 14 may extract the threat information at a specific cycle, such as a predetermined time or date received via the user management terminal 22.

Next, the priority management unit 14 classifies the extracted threat information based on the results of being malicious and suspicious. Furthermore, the priority management unit 14 accumulates frequencies including the target sites for each classification result at step S18.

Thereafter, the priority management unit 14 arranges the cumulative result values in descending order, and determines the checking priorities of the target sites. For example, the priority management unit 14 determines the checking priority of a target site, classified as malicious, to correspond to a hacking site. The priority management unit 14 determines the checking priority of a target site, classified as suspicious, to correspond to a suspicious site. Thereafter, the priority management unit 14 applies the result of the determination of the corresponding target site to the target site DB 24a at step S20.

In FIG. 3, checking priorities have been illustrated as being primarily determined based on the results of the malicious link detection of target sites stored in the detection information DB 24c, and checking priorities have been illustrated as being secondarily determined based on threat information about the target sites stored in the threat information DB 24b. However, the order of the determinations may be changed if necessary.

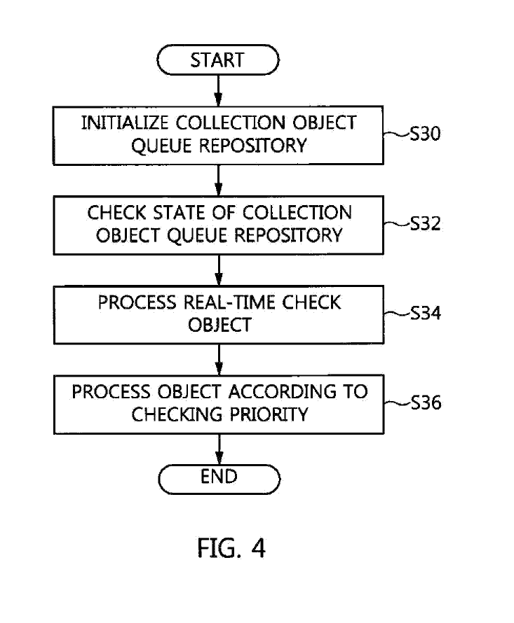

FIG. 4 is a flowchart illustrating a procedure for assigning target sites to a queue repository and managing the target sites in order to process the collection and analysis of malicious links in parallel in the method of automatically detecting a malicious link according to an embodiment of the present invention.

First, the target site assignment module 14a of the priority management unit 14 performs initialization on the collection object queue repository 24f at step S30. In a criterion for the initialization, real-time checking queues and queues ranging from a level 1 Level-1 to a level n Level-n may be configured as queues according to hacking sites, suspicious sites, abnormal sites and normal sites that have checking priorities and that have been generated for specific purposes via the user management terminal 22, and are then initialized. Furthermore, the queues may be configured based on each processing time, for example, 5 minutes, 10 minutes, 30 minutes, or a 1 hour, other than checking priorities, and then the initialization may be performed. If the queues are initialized for each time span, the number of target sites in each queue is determined based on the processing time of the malicious link collection unit 16 and the malicious link analysis unit 18.

Thereafter, the target site assignment module 14a checks the number of target site URLs in each of the queues of the collection object queue repository 24f. If the number of target site URLs is not present, the target site assignment module 14a determines whether to assign a target site URL to each of the queues of the collection object queue repository 24f at step S32.

Thereafter, if there is a task requested by the user management terminal 22 in order to detect the malicious link of a specific target site in real time, the target site assignment module 14a inserts a corresponding target site URL into the real-time checking queue of the collection object queue repository 24f at step S34.

Thereafter, the target site assignment module 14a inserts the URL of a target site whose checking priority has been determined by the checking priority determination module 14b into a queue suitable for the priority of the collection object queue repository 24f at step S36.

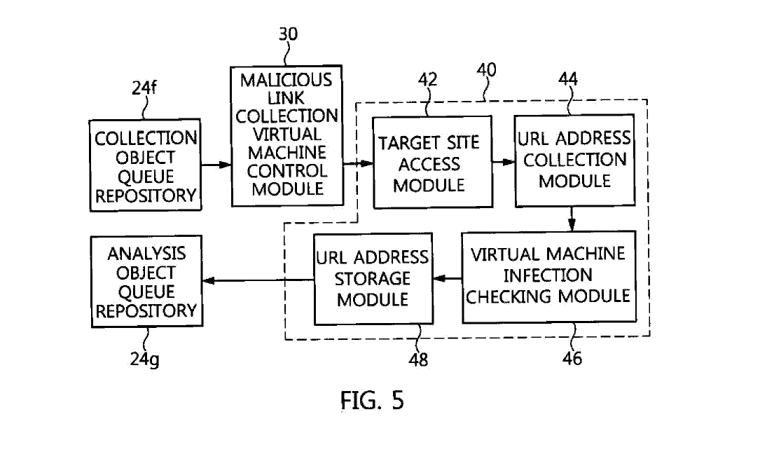

FIG. 5 is a diagram illustrating the internal components of the malicious link collection module 17 of FIG. 2. In FIG. 5, the malicious link collection module 17 and the internal components have been represented as modules, but may be called respective module units.

The malicious link collection module 17 includes a malicious link collection virtual machine control module 30 and a virtual machine 40. The virtual machine 40 includes a target site access module 42, a URL address collection module 44, a virtual machine infection checking module 46, and a URL address storage module 48.

The malicious link collection virtual machine control module 30 checks the checking priorities of target sites that have been designated via the user management terminal 22 and from which malicious links are to be collected. Furthermore, the malicious link collection virtual machine control module 30 receives target sites present in a corresponding queue of the collection object queue repository 24f, and executes the virtual machine 40.

Prior to accessing a target site via a web browser, the target site access module 42 changes its Internet Protocol (IP) address in order to prevent the IP address from being exposed by accessing a malicious server in which a malicious link is present. In this case, a known proxy server or virtual private network (VPN) may be used as a means for changing the IP address.

The target site access module 42 checks whether the corresponding target site is an important site previously designed by the user management terminal 22. If the corresponding target site is an important site, the target site access module 42 accesses only the corresponding single target site by executing only a single web browser. If the corresponding target site is not an important site, the target site access module 42 accesses several target sites by executing a plurality of web browsers.

Furthermore, if the target site access module 42 receives code “403 forbidden” returned by a web server while visiting a target site, it may change the IP address for URL access. In this case, the code “403 forbidden” is an HTTP state code returned by a web server when a user requests a web page or media not permitted by a server. In other words, this means that the server has denied permission for access to a page.

If the target site checked by the target site access module 42 is an important site, the URL address collection module 44 collects the addresses of URLs based on network snipping.

If the target site checked by the target site access module 42 is not an important site, the URL address collection module 44 collects the addresses of URLs based on web browser hooking.

The virtual machine infection checking module 46 checks whether the virtual machine 40 has been infected with malware. For example, the virtual machine infection checking module 46 may check whether the virtual machine 40 has been infected with malware based on a case where when the virtual machine infection checking module 46 visits a target site via a web browser, the child process of a name that has not been previously known has been generated in the web browser or the virtual machine infection checking module 46 has accessed an execution file that has not been previously known.

Furthermore, if the virtual machine 40 is found to have been infected with malware, the virtual machine infection checking module 46 requests recovery from the malicious link collection virtual machine control module 30.

The URL address storage module 48 stores the addresses of URLs, collected by the URL address collection module 44, in the analysis object queue repository 24g.

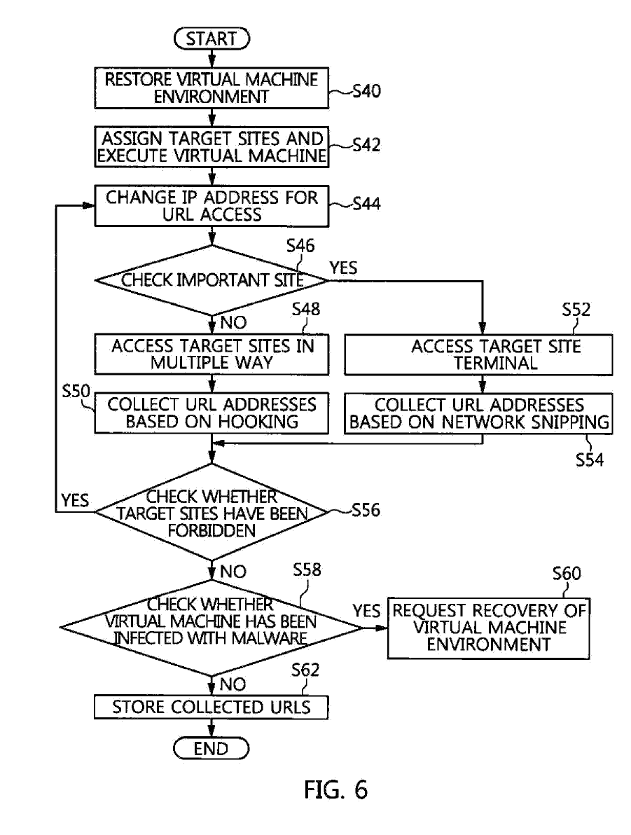

FIG. 6 is a flowchart illustrating the dynamic procedure of the malicious link collection module 17 for collecting malicious links using a dynamic behavior simulation method in the method of automatically detecting a malicious link according to an embodiment of the present invention.

First, the malicious link collection virtual machine control module 30 restores a virtual machine environment to a clean environment in which a target site has not been visited once via a web browser at step S40.

Next, the malicious link collection virtual machine control module 30 checks the checking priorities of target sites which have been designated via the user management terminal 22 and from which malicious links are to be collected. Furthermore, the malicious link collection virtual machine control module 30 receives target sites from a corresponding queue of the collection object queue repository 24f and executes the virtual machine 40 at step S42.

When the virtual machine 40 is executed, the target site access module 42 changes an IP address in order to prevent the IP address from being exposed by accessing a malicious server including a malicious link prior to accessing a target site via a web browser at step S44.

Thereafter, the target site access module 42 checks whether the corresponding target site is an important site previously designated via the user management terminal 22 at step S46.

If, as a result of the checking, the corresponding target site is found not to be an important site, the target site access module 42 accesses several target sites by executing a plurality of web browsers at step S48. Accordingly, the URL address collection module 44 performs web browser hooking-based URL address collection at step S50.

If, as a result of the checking, the corresponding target site is found to be an important site, the target site access module 42 accesses only the single target site by executing only a single web browser at step S52. Accordingly, the URL address collection module 44 collects the addresses of URLs based on network snipping at step S54.

If the target site access module 42 receives code “403 forbidden” from a web server while visiting a target site at step S56, it returns to step S44 and changes the IP address for URL access.

While collecting the addresses of the URLs, the virtual machine infection checking module 46 checks whether the virtual machine 40 has been infected with malware at step S58.

If, as a result of the checking, the virtual machine 40 is found to have been infected with malware, the virtual machine infection checking module 46 requests recovery from the malicious link collection virtual machine control module 30 at step S60.

Thereafter, the URL address storage module 48 stores the addresses of the URLs, collected by the URL address collection module 44, in the analysis object queue repository 24g at step S62.

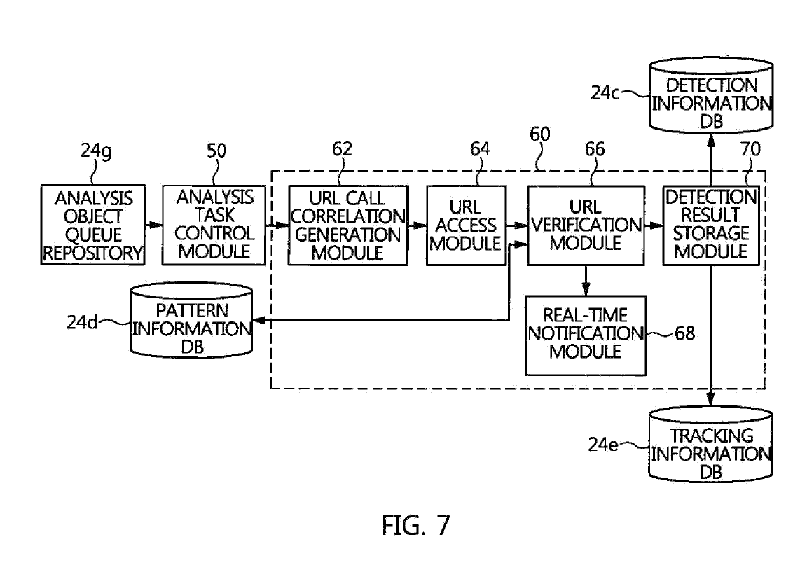

FIG. 7 is a diagram illustrating the internal components of the malicious link analysis module 19 of FIG. 2. In FIG. 7, the malicious link analysis module 19 and the internal components have been represented as modules, but may be called respective module units.

The malicious link analysis module 19 includes an analysis task control module 50 and an analysis module 60. The analysis module 60 includes a URL call correlation generation module 62, a URL access module 64, a URL verification module 66, a real-time notification module 68, and a detection result storage module 70.

The analysis task control module 50 checks the checking priorities of target sites which have been designated via the user management terminal 22 and on which an analysis of malicious links is to be performed. Furthermore, the analysis task control module 50 extracts the URLs of target sites from a corresponding queue of the analysis object queue repository 24g. Furthermore, the analysis task control module 50 rapidly analyzes the URLs of the target sites in parallel by executing the analysis module 60 in a multiple way.

The URL call correlation generation module 62 generates a call correlation based on referer information included in the configuration information of the URLs of the target sites.

If a URL is a malicious link, the URL access module 64 changes an IP address in order to prevent the IP address from being exposed by accessing a malicious server prior to accessing the URL. In this case, a known proxy server or VPN may be used as a means for changing the IP address.

The URL access module 64 accesses the corresponding URL, and stores the URL as a source file. If the URL access module 64 receives code “403 forbidden” from a web server while visiting the corresponding URL, it may change the IP address for URL access.

The URL verification module 66 extracts suspicious and malicious patterns from the pattern information DB 24d, and determines the type of malicious link with respect to the address of the corresponding URL and the content of the source file through pattern matching and the URL call correlation. In this case, the type of defined malicious link is classified as malicious, suspicious, or abnormal. “Malicious” means a URL including a malicious pattern and “Suspicious” means a URL including a suspicious pattern. “Abnormal” may mean a URL that does not include a malicious pattern and a suspicious pattern, but in which the call code of a child URL in the source code of an upper parent URL has been obfuscated not in a common HTML form if the upper parent URL is present after a call correlation between URLs is checked.

Furthermore, the URL verification module 66 stores the address of a URL and an IP address determined to be malicious and suspicious in the pattern information DB 24d as a malicious pattern or suspicious pattern.

The real-time notification module 68 checks whether a URL verified by the URL verification module 66 is a malicious link. The real-time notification module 68 notifies an information specialist or security control person of a URL that is found to be a malicious link in real time via e-mail or SMS.

The detection result storage module 70 stores a result, verified by the URL verification module 66, in the detection information DB 24c and the tracking information DB 24e. For example, the detection result storage module 70 stores the URL of a target site, detected as a malicious link, in the detection information DB 24c. Furthermore, the detection result storage module 70 stores the URL of the malicious link in the tracking information DB 24e in order to track the real-time changing state of the malicious link.

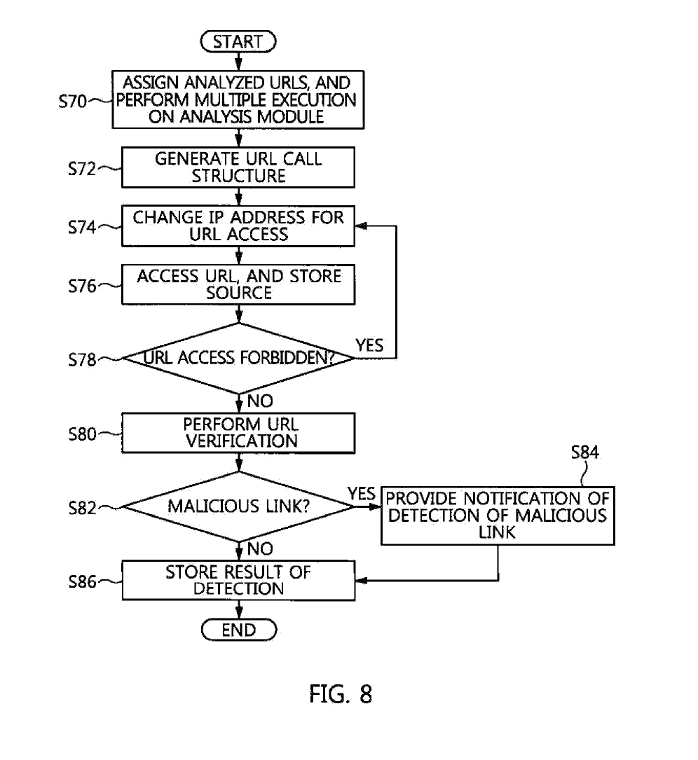

FIG. 8 is a flowchart illustrating the dynamic procedure of the malicious link analysis module 19 for detecting and analyzing a malicious link in the method of automatically detecting a malicious link according to an embodiment of the present invention.

First, the analysis task control module 50 checks the checking priorities of target sites that have been designed through the user management terminal 22 and on which an analysis of malicious links is to be performed and extracts the URLs of target sites from a corresponding queue of the analysis object queue repository 24g. The analysis task control module 50 rapidly analyzes the URLs of the target sites based on the URLs of the extracted target sites by executing a corresponding analysis module 60 in a multiple way at step S70.

When the analysis module 60, the URL call correlation generation module 62 of the analysis module 60 generates a call correlation based on referer information included in, the configuration information of the URLs of the target sites at step S72.

Furthermore, if a URL is a malicious link, prior to access to the URL, the URL access module 64 of the analysis module 60 changes an IP address in order to prevent the IP address from being exposed due to access a malicious server at step S74.

After performing a change of the IP address, the URL access module 64 accesses the corresponding URL and stores the URL as a source file at step S76.

If the URL access module 64 receives code “403 forbidden” from a web server while accessing the corresponding URL (“Yes” at step S78), it returns to step S74 and changes the IP address for URL access.

Thereafter, the URL verification module 66 performs the verification of the corresponding URL at step S80. That is, the URL verification module 66 may extract suspicious patterns and malicious patterns from the pattern information DB 24d and determine the type of malicious link for the address of the URL and the content of the source file through pattern matching and a URL call correlation. In this case, the type of defined malicious link may be classified as malicious, suspicious, or abnormal. The address of a URL and an IP address determined to be malicious or suspicious are stored in the pattern information DB 24d as a malicious pattern or suspicious pattern and generated as a new pattern.

Furthermore, the real-time notification module 68 checks whether a URL verified by the URL verification module 66 is a malicious link at step S82.

If, as a result of the checking, the URL is found to be a malicious link, the real-time notification module 68 notifies an information specialist or security control person of the URL in real time via e-mail or SMS at step S84.

Furthermore, the detection result storage module 70 stores a result of the verification of the URL verification module 66 in the detection information DB 24c and the tracking information DB 24e at step S86. That is, the detection result storage module 70 stores the URL of a target site detected as a malicious link in the detection information DB 24c and stores the URL of the malicious link in the tracking information DB 24e in order to track the real-time changing state of the malicious link.

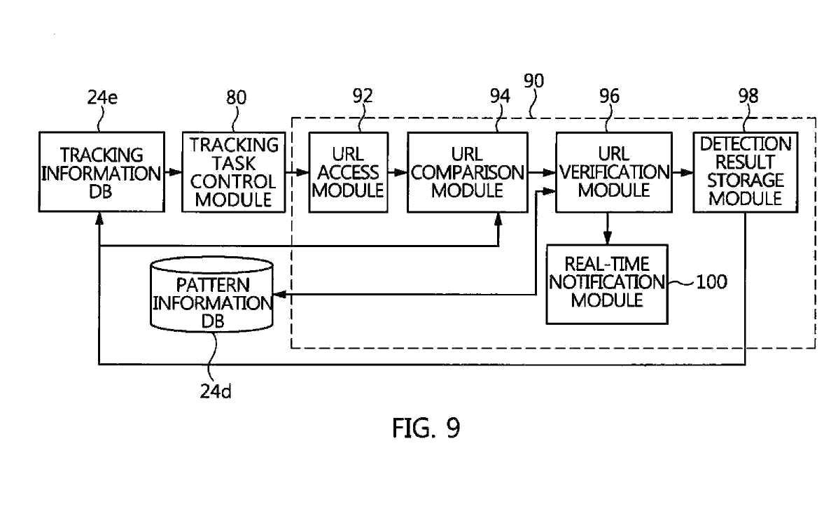

FIG. 9 is a diagram illustrating the internal components of the malicious link tracking module 21 of FIG. 2. In FIG. 9, the malicious link tracking module 21 and the internal components thereof have been represented as being modules, but they may be called respective module units.

The malicious link tracking module 21 includes a tracking task control module 80 and a tracking module 90. The tracking module 90 includes a URL access module 92, a URL comparison module 94, a URL verification module 96, a detection result storage module 98, and a real-time notification module 100.

The tracking task control module 80 extracts the URL of a malicious link for tracking the real-time changing state of the malicious link from the tracking information DB 24e. The tracking task control module 80 rapidly performs URL tracking in parallel by performing the tracking module 90 in a multiple way based on the extracted URL of the malicious link.

If the extracted URL of the malicious link is a malicious link, the URL access module 92 changes an IP address in order to prevent the IP address from being exposed by accessing a malicious server prior to accessing the extracted URL. In this case, a known proxy server or VPN may be used as a means for changing the IP address. Furthermore, the URL access module 92 accesses the corresponding URL and stores the URL as a source file.

If the URL access module 92 receives code “403 forbidden” from a web server while accessing the corresponding URL, it may change the IP address for URL access.

The URL comparison module 94 compares the MD5 value of the source file of the URL access module 92 with the MD5 value of the source file of the same URL that has been previously tracked or a source file that has been previously stored based on information within the tracking information DB 24e.

If, as a result of the comparison, the MD4 values are found to be the same, the URL verification module 96 identically applies a result of the previous verification of the URL comparison module 94 so that the URL verification process is not repeatedly performed. If, as a result of the comparison, the MD4 values are found not to be the same, the URL verification module 96 identically applies a result of the previous verification of the URL comparison module 94 and repeatedly performs the URL verification process.

Furthermore, the URL verification module 96 extracts suspicious and malicious patterns from the pattern information DB 24d, and verifies the changing state of the type of malicious link through pattern matching between the address of the URL and the content of the source file. Furthermore, the URL verification module 96 verifies whether the malicious link has changed from a deactivation to an activation state.

The detection result storage module 98 stores a result of the real-time changing state of the malicious link in the tracking information DB 24e.

The real-time notification module 100 checks whether the state of the verified URL has been changed through the URL verification module 96. The real-time notification module 100 notifies an information specialist or security control person of the changed URL in real time via e-mail or SMS.

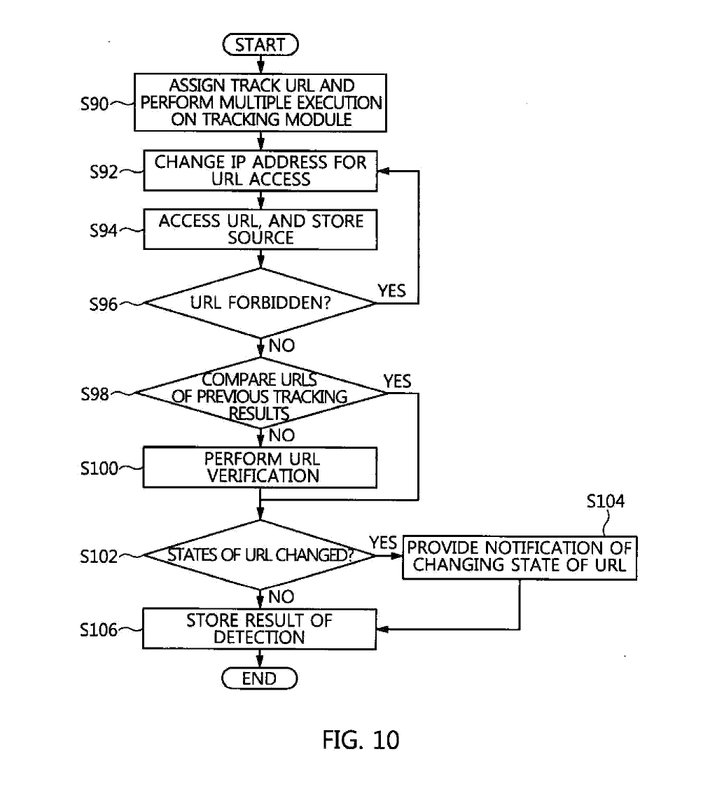

FIG. 10 is a flowchart illustrating the dynamic procedure of the malicious link tracking module 21 for tracking the real-time changing state of a malicious link and providing notification of the malicious link in the method of automatically detecting a malicious link according to an embodiment of the present invention.

First, the tracking task control module 80 of the malicious link tracking module 21 extracts the URL of a malicious link for tracking the real-time changing state of the malicious link from the tracking information DB 24e. Furthermore, the tracking task control module 80 rapidly performs URL tracking in parallel by performing the tracking module 90 in a multiple way based on the extracted URL of the malicious link at step S90.

Next, if the extracted URL of the malicious link is a malicious link, the URL access module 92 of the tracking module 90 changes an IP address in order to prevent the IP address from being exposed by accessing a malicious server prior to accessing the extracted URL at step S92.

After the IP address has been changed, the URL access module 92 accesses the corresponding URL and stores the URL as a source file at step S94.

If the URL access module 92 receives code “403 forbidden” from a web server while accessing the corresponding URL, it returns step S92 and changes the IP address for URL access at step S96.

Thereafter, the URL comparison module 94 compares the MD5 value of the source file with the MD5 value of the source file of the same URL that has been previously tracked based on information within the tracking information DB 24e at step S98.

If, as a result of the comparison, the MD4 values are found not to be the same, the URL verification module 96 identically applies a result of the previous verification of the URL comparison module 94 and repeatedly performs the URL verification process at step S100. If, as a result of the comparison, the MD4 values are found to be the same, the URL verification module 96 identically applies a result of the previous verification of the URL comparison module 94 so that the URL verification process S100 is not repeatedly performed.

When performing such URL verification, the URL verification module 96 extracts suspicious and malicious patterns from the pattern information DB 24d and verifies the changing state of the type of malicious link through pattern matching between the address of the URL and the content of the source file. Furthermore, the URL verification module 96 verifies whether the malicious link has changed from a deactivation to an activation state.

After the URL verification has been completed, the real-time notification module 100 checks whether the state of the verified URL has been changed via the URL verification module 96 at step S102.

If, as a result of the checking, the state of the verified URL is found to have been changed, the real-time notification module 100 notifies an information specialist or security control person of the changed URL in real time via e-mail or SMS at step S104.

Furthermore, the detection result storage module 98 stores the result of the real-time changing state of the malicious link in the tracking information DB 24e at step S5106.

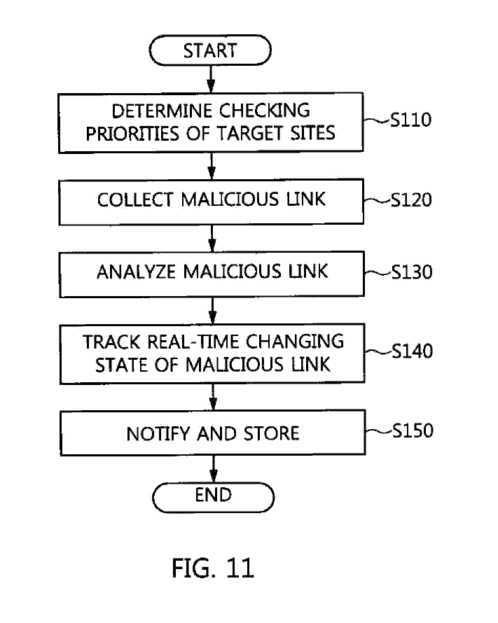

FIG. 11 is a general flowchart illustrating the method of automatically detecting a malicious link according to an embodiment of the present invention.

The method of automatically detecting a malicious link according to the present embodiment includes determining the checking priorities of target sites based on open threat information related to the target sites over the Internet 10 and information about the detection of the target sites at step S110, collecting the malicious links of each target site using a dynamic behavior simulation method at step S120, analyzing a call correlation between the collected malicious links and determining the type of malicious link through pattern matching at step S130, tracking the real-time changing state of a malicious link at step S140, and providing notification of the tracked real-time changing state of the malicious link and storing the malicious link at step S150.

In this case, it is considered that step S110 can be sufficiently understood from the description of FIG. 3.

Furthermore, it is considered that step S120 can be sufficiently understood from the descriptions of FIGS. 5 and 6.

Furthermore, it is considered that step S130 can be sufficiently understood from the descriptions of FIGS. 7 and 8.

Furthermore, it is considered that steps S140 and S150 can be sufficiently understood from the descriptions of FIGS. 9 and 10.

In accordance with at least one embodiment of the present invention, malicious links can be detected and the distribution paths of the malicious links can be checked because a call correlation between URLs is analyzed and pattern matching is performed. Accordingly, the evidence of the distribution of malware can be acquired.

Furthermore, in at least one embodiment of the present invention, a dangerous target site can be rapidly checked efficiently by determining the checking priorities of target sites in order to rapidly detect malicious links that distribute malware.

In accordance with at least one embodiment of the present invention, target sites of high importance can be first checked rapidly because the checking priorities of target sites are determined based on open threat information related to the target sites over the Internet and information about the detection of the target sites.

Furthermore, malicious links can be collected without omission because the malicious links are collected using a dynamic behavior simulation method. Furthermore, the distribution paths of malicious links can be checked because a call correlation between collected malicious links is analyzed and determined through pattern matching.

Furthermore, there is an advantage in that measures can be rapidly taken because the state of a malicious link that varies in real time is tracked and an information specialist or security control person is notified of the real-time changing state in real time via SMS. That is, an information specialist or security control person can rapidly take measures against a malicious link that distributes malware within a short period of time and then disappears.

As described above, the optimum embodiments have been disclosed in the drawings and the specification. Although specific terms have been used herein, they have been used merely for the purpose of describing the present invention, but have not been used to restrict their meanings or limit the scope of the present invention set forth in the claims. Accordingly, it will be understood by those having ordinary knowledge in the relevant technical field that various modifications and other equivalent embodiments can be made. Therefore, the true range of protection of the present invention should be defined based on the technical spirit of the attached claims.

What is claimed is:

1. An apparatus for automatically detecting a malicious link, comprising:
a threat information collection unit configured to collect open threat information related to target sites and to identify whether a malicious link is present in each of the target sites;
a priority management unit configured to determine priorities of the target sites and to perform assignment and management of the target sites in order to collect and analyze a malicious link;
a malicious link collection unit configured to collect a uniform resource locator (URL) of the malicious link from the target sites;
a malicious link analysis unit configured to analyze a call correlation based on the collected URL of the malicious link and to analyze the malicious link through pattern matching; and
a malicious link tracking unit configured to track a real-time changing state of the analyzed malicious link.

2. The apparatus of claim 1, wherein:
the threat information collection unit comprises one or more threat information collection modules; and
the threat information collection module accesses a specific web site that discloses information about the malicious link based on a list of previously stored target sites, collects information about a history of distribution of the malicious link related to the specific web site, and identifies whether a malicious link is present in each of the target sites.

3. The apparatus of claim 1, wherein the priority management unit comprises:
a checking priority determination module configured to check a checking priority object based on a list of previously stored target sites and to determine a priority of each of the target sites based on previously stored threat information and detection information; and
a target site assignment module configured to assign priorities to the respective target sites based on results of the determination of the priorities of the respective target sites.

4. The apparatus of claim 1, wherein:
the malicious link collection unit comprises one or more malicious link collection modules; and
the malicious link collection module collects the URL of the malicious link from the target sites using a dynamic behavior simulation method.

5. The apparatus of claim 4, wherein the malicious link collection module comprises:
a target site access module configured to change an Internet Protocol (IP) address prior to accessing the target sites and to access the target sites;
a URL address collection module configured to collect addresses of the URLs of the accessed target sites; and
a URL address storage module configured to store the collected addresses of the URLs.

6. The apparatus of claim 5, wherein the URL address collection module collects the addresses of the URLs based on network snipping if the target sites are important sites.

7. The apparatus of claim 5, wherein the URL address collection module collects the addresses of the URLs based on web browser hooking if the target sites are not important sites.

8. The apparatus of claim 5, wherein the malicious link collection module further comprises a virtual machine infection checking module configured to check whether a virtual machine has been infected with malware.

9. The apparatus of claim 1, wherein:
the malicious link analysis unit comprises one or more malicious link analysis modules; and
the malicious link analysis module comprises:
a URL call correlation generation module configured to generate a URL call correlation based on referer information included in configuration information of the URLs of the target sites;
a URL access module configured to change an IP address prior to accessing a URL, to access the URL, and to store the accessed URL as a source file;
a URL verification module configured to determine a type of malicious link with respect to an address of the URL and the content of the source file through pattern matching and the URL call correlation;
a real-time notification module configured to provide notification of a URL, determined to be a malicious link, in real time; and
a detection result storage module configured to store a result of the determination of the URL verification module.

10. The apparatus of claim 1, wherein:
the malicious link tracking unit comprises one or more malicious link tracking modules; and
the malicious link tracking module comprises:
a URL access module configured to change an IP address prior to accessing a URL, to access the URL, and to store the accessed URL as a source file;
a URL comparison module configured to compare the source file of the URL access module with a source file of the same URL that has been previously tracked based on previously stored tracking information;
a URL verification module configured to verify a changing state of a malicious link in real time by performing pattern matching on an address of the URL and content of the source file based on previously stored suspicious patterns and malicious patterns;
a detection result storage module configured to store a result of the real-time changing state of the malicious link; and
a real-time notification module configured to provide notification of a changed URL in real time as the state of the URL verified via the URL verification module is changed.

11. A method of automatically detecting a malicious link, comprising:
determining, by a priority management unit, checking priorities of target sites based on open threat information and detection information related to the target sites;
collecting, by a malicious link collection unit, a URL of a malicious link from the target sites;
analyzing, by a malicious link analysis unit, a call correlation based on the collected URL of the malicious link and analyzing the malicious link through pattern matching; and
tracking, by a malicious link tracking unit, a real-time changing state of the analyzed malicious links.

12. The method of claim 11, wherein determining the checking priorities of the target sites comprises:
checking a checking priority object based on a list of previously stored target sites, and determining a priority of each of the target sites based on previously stored threat information and detection information; and
assigning priorities to the respective target sites based on a result of the determination of the priorities of the respective target sites.

13. The method of claim 11, wherein collecting the URL of the malicious link comprises collecting the URL of the malicious link from the target sites using a dynamic behavior simulation method.

14. The method of claim 11, wherein collecting the URL of the malicious link comprises:
changing an Internet Protocol (IP) address prior to accessing the target sites and to access the target sites;
collecting addresses of the URLs of the accessed target sites; and
storing the collected addresses of the URLs.

15. The method of claim 14, wherein collecting the URL of the malicious link comprises collecting the addresses of the URLs based on network snipping if the target sites are important sites.

16. The method of claim 14, wherein collecting the URL of the malicious link comprises collecting the addresses of the URLs based on web browser hooking if the target sites are not important sites.

17. The method of claim 11, wherein analyzing the malicious links comprises:
generating the URL call correlation based on referer information included in configuration information of the URLs of the target sites;
changing an IP address prior to access to a URL, accessing the URL, and storing the accessed URL as a source file;
determining a type of malicious link based on the URL call correlation and pattern matching performed on an address of the URL and the content of the source file based on previously stored suspicious patterns and malicious patterns;
providing notification of a URL determined to be a malicious link in real time; and
storing a result of the determination of the type of malicious link.

18. The method of claim 11, wherein tracking the real-time changing state of the analyzed malicious links comprises:
changing an IP address prior to accessing a URL, accessing the URL, and storing the accessed URL as a source file;
comparing the stored source file with a source file of the same URL that has been previously tracked based on previously stored tracking information;
verifying a changing state of a malicious link in real time by performing pattern matching on an address of the URL and content of the source file based on previously stored suspicious patterns and malicious patterns;
storing a result of the real-time changing state of the malicious link; and
providing notification of a changed URL in real time if the state of the verified URL is changed.
